(19) United States
(12) Patent Application Publication
(10) Pub. No.: US 2015/0278751 A1
(43) Pub. Date: Oct. 1, 2015

(54) SYSTEMS AND METHODS FOR QUALITY MILESTONE MANAGEMENT

(71) Applicant: Level 3 Communications, LLC, Broomfield, CO (US)

(72) Inventors: Cecil Sunder, Broomfield, CO (US); Ophir Rahmani, Arvada, CO (US); James Male, Denver, CO (US)

(73) Assignee: Level 3 Communications, LLC, Broomfield, CO (US)

(21) Appl. No.: 14/604,084

(22) Filed: Jan. 23, 2015

Related U.S. Application Data
(60) Provisional application No. 61/973,076, filed on Mar. 31, 2014.

(51) Int. Cl. G06Q 10/06

(52) U.S. Cl. CPC G06Q 10/063114

(57) ABSTRACT

Implementations described and claimed herein provide systems and methods for tracking and managing order milestones for efficient management to increase customer satisfaction in delivering a VPN or other telecommunications service. In some implementations, a quality milestone manager permits a user to quickly obtain a status of orders, tasks, and a performance of the various functional groups involved in delivering an order. The quality milestone manager integrates with multiple disparate order entry systems and workflow and process systems and extracts information corresponding to the tasks to deliver each order. The information is correlated and normalized into aggregated milestones, which are output as a tiered management view with predictive key performance indicators.

### CROSS-REFERENCE TO RELATED APPLICATIONS

The present application claims benefit under 35 U.S.C. §119(e) to U.S. Provisional Patent Application No. 61/973,076, entitled “System and Methods for Quality Milestone Management” and filed on Mar. 31, 2014, which is specifically incorporated by reference herein in its entirety.

### TECHNICAL FIELD

Aspects of the present disclosure relate to order tracking and management, among other functions, and more particularly to the tracking and management of milestones and tasks for orders.

### BACKGROUND

Industries delivering complex services, such as the telecommunications industry, generally involve multiple layers of provisioning and design to fulfill an order, often with parallel workflows ongoing and various responsible parties. For example, an order for a Virtual Private Network (VPN) is delivered through the completion of multiple tasks by several different groups using disparate systems and processes. Conventionally, a telecommunications workflow generates tasks to deliver a VPN order, and once a task is completed, a new task is generated. As such, only a few tasks are open at once with many tasks on hold until a previous task is completed. The tasks on hold are invisible until they become open. Accordingly, it is often difficult to manage and track the progress of an order and keep the customer informed about a predicted delivery timeline. These challenges are further exacerbated by the use of disparate systems and having different groups responsible for each of the tasks. Often, to obtain an overall status of an order each of the parties responsible for the various open tasks has to be consulted for a status and the status manually input into a spreadsheet or similar document for tracking.

It is with these observations in mind, among others, that various aspects of the present disclosure were conceived and developed.

### SUMMARY

Implementations described and claimed herein address the foregoing problems, among others, by providing systems and methods for managing order milestones. In one implementation, a plurality of orders are obtained using disparate quoting systems. Milestone information corresponding to the plurality of orders is extracted. The milestone information includes a plurality of tasks for each of the plurality of orders and is correlated into a table of milestones for the plurality of orders. The table of milestones identifies a start date, an end date, and a status for each of the plurality of tasks. Aggregated milestones are generated from the table of milestones. The aggregated milestones include aggregated orders and milestone management information. The aggregated orders detail an amount of completed orders from the plurality of orders and an amount of pending orders from the plurality of orders. The milestone management information detail the plurality of tasks for each of the orders. The aggregated milestones are output in a tiered view for display on a user device.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 is an example order management system, including a quality milestone manager running on a computer server or other similar device coupled with a network, for tracking and managing a plurality of orders.

FIG. 2 illustrates example operations for quality milestone management.

FIG. 3 shows an example customer expectation user interface generated by the quality milestone manager, the user interface being displayed in a browser window of a computing device and displaying completed and pending orders.

FIG. 4 displays an example function group user interface with key performance indicators.

FIG. 5 shows another example function group user interface with key performance indicators.

FIG. 6 displays an example milestone view with tasks for an order and parties responsible for the tasks.

FIG. 7 shows an example order level drill down view of an order and associated tasks.

FIG. 8 is an example of a computing system that may implement various systems and methods discussed herein.

### DETAILED DESCRIPTION

Aspects of the present disclosure involve systems and methods for tracking and managing order milestones for efficient management to increase customer satisfaction in delivering a Virtual Private Network (VPN) or other telecommunications services. In one aspect, end to end order management and risk profiling are provided with visibility and transparency of all VPN orders and associated tasks. A quality milestone manager permits a user, such as a Customer Care Manager (CCM), to quickly obtain a status of orders, tasks, and a performance of the various functional groups responsible for completing the orders. The quality milestone manager integrates with multiple disparate order entry systems and workflow and process systems and extracts information corresponding to the tasks to deliver each order. The information is correlated and normalized into aggregated milestones, which are output as a tiered management view with predictive key performance indicators. The tiered management view includes, without limitation: an aggregated order view with high level information of completed and pending orders; a milestone management view with individual tasks and owners of those tasks for an order; a global view of functional groups and their performance; and an order drilldown view with more detailed information about various tasks for an order. The tiered management view provides a single cohesive place to view one or more orders from start to finish.

The various systems and methods disclosed herein provide for quality milestone management of a plurality of orders completed using disparate systems and processes. The example implementations discussed herein reference the telecommunications industry and VPN orders. However, it will be appreciated by those skilled in the art that the presently disclosed technology is applicable to other industries and data involving the sale and delivery of complex services, such as the shipping industry, financial industry, commercial industry, and the like.

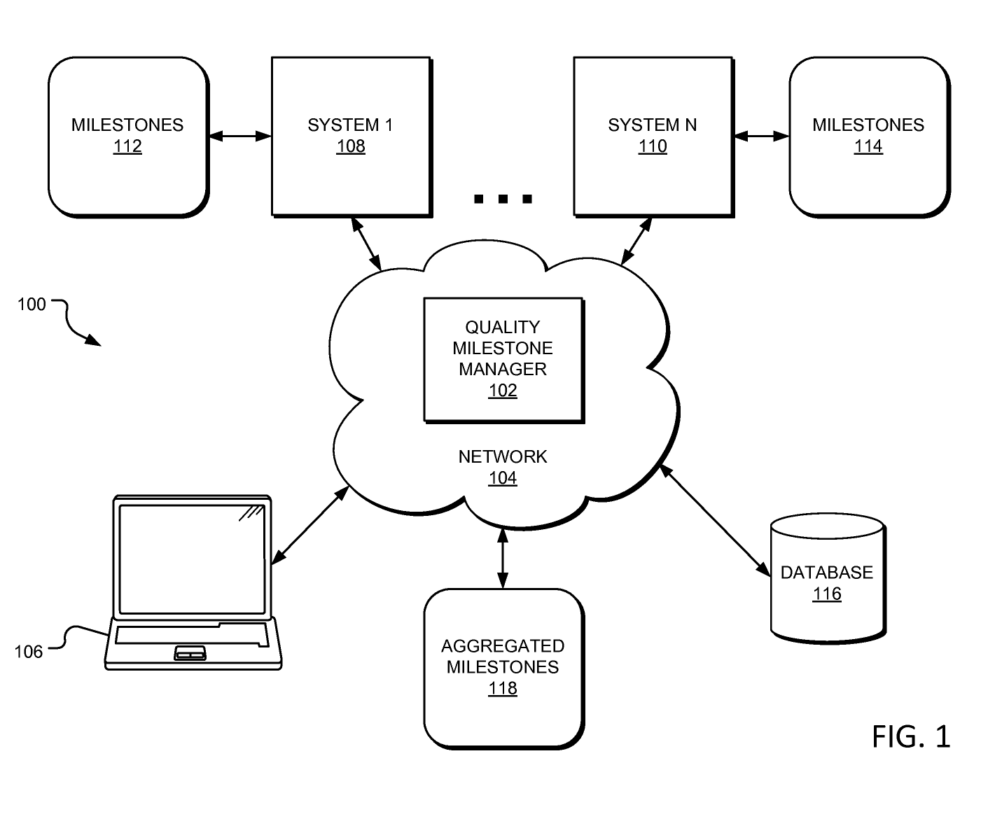

Referring to FIG. 1, an example order management system 100 for tracking and managing a plurality of VPN orders is shown. In one implementation, a user accesses and interacts with a quality milestone manager 102 to process and track orders via a network 104 (e.g., the Internet) using a user device 106. The user may be any person associated with the company offering services, such as a sales representative, a sales engineer, a CCM, service delivery personnel, or internal or external auditors.

The user device 106 is generally any form of computing device capable of interacting with the network 104, such as a work station, personal computer, terminal, portable computer, mobile device, smartphone, tablet, multimedia console, etc. The network 104 is used by one or more computing or data storage devices (e.g., one or more systems 108-110 and one or more databases 116) for implementing the quality milestone manager 102, and other services, applications, or modules in the order management system 100.

In one implementation, the network 104 includes a server hosting a website or an application that the user may visit to access the quality milestone manager 102 and/or other network components. The server may be a single server, a plurality of servers with each such server being a physical server or a virtual machine, or a collection of both physical servers and virtual machines. In another implementation, a cloud hosts one or more components of the order management system 100. The user devices 106, the server, and other resources connected to the network 104 may access one or more other servers to access to one or more websites, applications, web services interfaces, storage devices, computing devices, etc. that are used for quality milestone management. The server may also host a search engine that the order management system 100 uses for accessing, searching for, and modifying order data, task data, milestone data, key performance indicators, and/or other information.

As can be understood from FIG. 1, in one implementation, the systems 108-110 generate a quote for delivering a telecommunication service, such as a VPN, based on order attributes. For example, a sales engineer or other responsible party may utilize one of the systems 108-110 to input order attributes to receive a quote for a customer for a VPN and/or other telecommunications services. The systems 108-110 may include various quoting systems, tools, and/or applications capable of generating a quote for delivering a telecommunication service, such as a VPN.

In one implementation, the sales engineer enters customer information and attributes of the VPN to receive a quote for the customer, generated by one of the systems 108-110. Once the customer accepts the quote, an order is submitted. In one implementation, the sales engineer attaches product information or technical attributes to the quote and/or order.

After the order is submitted, multiple tasks are assigned to various responsible parties for completion using one or more of the systems 108-110. The VPN is designed and provisioned including the logical and physical inventory design (e.g., a design of the physical transport layer of the VPN and the logical interfaces) using the systems 108-110, which generally involve disparate workflow systems and processes. To facilitate the completion of the order in view of the disparate workflow systems and processes, in one implementation, the CCM governs the management of the VPN orders from the time each of the orders is entered until an operational VPN is delivered to the customer according to the customer's expectations.

In one implementation, each of the systems 108-110 includes milestone information 112-114 for multiple orders. The milestone information 112-114 may be generated by different functional groups using the systems 108-110 to complete tasks for delivering an order for a telecommunications service. The functional groups may include, without limitation, a CCM group, a sale representative or order entry group, a design group, an IP group, a TDE group, an offnet group, and other groups assigned to work on one or more tasks corresponding to an order for one or more telecommunication services, such as a VPN.

The quality milestone manager 102 regularly queries each of the systems 108-110 and extracts the milestone information 112-114, including, for example, a task start date, a task end date, and a task status (e.g., pending, completed, or unassigned). The quality milestone manager 102 normalizes and correlates the milestone information 112-114 into aggregated milestones 118. Stated differently, the quality milestone manager 102 transforms, loads, and normalizes the milestone information 112-114 extracted from multiple disparate systems 108-110 to create an integrated tiered management view of pending and completed telecommunication service orders. In one implementation, the tiered management view includes: an aggregated order view with high level information of completed and pending orders; a milestone management view with individual tasks and owners of those tasks for an order; a global view of functional groups and their performance; and an order drilldown view with more granular detail about various tasks for an order. The tiered management view provides a single cohesive place to view one or more orders from start to finish. As such, the aggregated milestones 118 promotes revenue optimization and order efficiency with the visibility and transparency of orders in a unified platform.

The aggregated milestones 118 includes the milestone information 112-114 mapped from the different systems 108-110 into an integrated view of the of all tasks for an order and predictions for future tasks and key performance indicators. In one implementation, the quality milestone manager 102 maps all the tasks and milestones for a plurality of orders into a table from which the tiered management view is generated. The visibility and transparency of tasks for an order permits users to harness early completions by moving onto subsequent tasks immediately after the completion of a task while showing future tasks and predictions for those tasks. As such, a user, such as the CCM, may use the quality milestone manager 102 to identify delays in the order and delivery process, including functional groups responsible for the delays, to remedy the delays and provide the customer with a prediction for remaining time to complete various tasks and to deliver the operational VPN to the customer's satisfaction. The quality milestone manager 102 provides information on which orders or functional groups are at risk for missing customer commitment dates, which may be used to adjust the process to meet the dates or provide the customer with a more accurate prediction for delivery. Generally, the quality milestone manager 102 is a platform for monitoring tasks, orders, and groups to increase efficiency and provide the customer with more accurate predictions. In one implementation, the quality milestone manager 102 includes an email or other notification integration to parties responsible for the tasks and to the customer to provide a status of an order or task.

In one implementation, the quality milestone manager 102 generates analytics and business intelligence based on information from one or more orders. The analytics may include trends, for example, over intervals in a time period. The analytics may be used to identify an accountable party or issue, to prevent recurring defects, and to provide a snapshot of order quality and customer satisfaction. For example, if many of the orders for a VPN are held up by a particular person or functional group or the average task time for a functional group or person is consistently high or behind schedule, problems or other inefficiencies causing the delay may be identified and remedied.

The quality milestone manager 102 provides a single, cohesive location to track order and task completions and milestones, thereby efficiently managing the order process and collecting data for auditing and to assist in trend and high bar analysis to identify and address recurring problems or delays. This information may be used to optimize the sales process, improve order quality, and reduce delays and inefficiencies, thereby saving money and improving customer satisfaction.

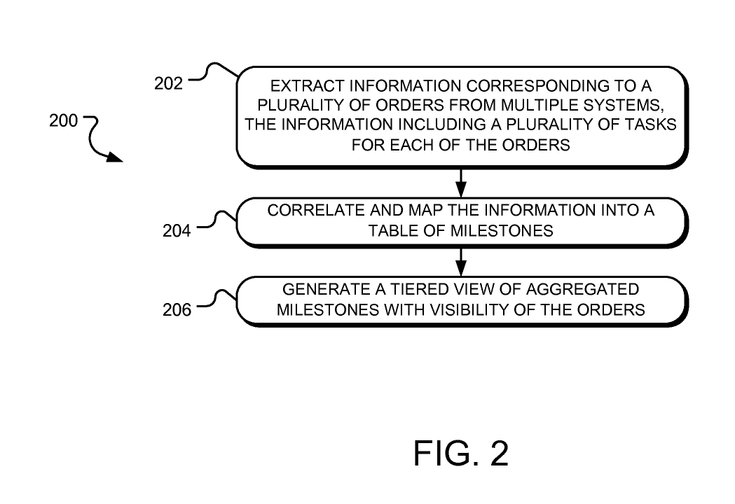

For a detailed description of example operations 200 for quality milestone management, reference is made to FIG. 2. In one implementation, an operation 202 extracts information corresponding to a plurality of orders (e.g., telecommunication services orders) from multiple disparate systems. The information includes a plurality of tasks for each of the orders, a start date and end date for each of the tasks, and a status of each of the tasks (e.g., pending, completed, and unassigned). In one implementation, the information is updated in substantially real time. In another implementation, the information is extracted on a regular basis (e.g., every few hours, once a day, etc.).

An operation 204 correlates and maps the information into a table of milestones for each of the orders. For each of the orders, the table of milestones includes the plurality of tasks for each of the orders, the start date and end date of each of the tasks, and the status of each of the tasks. An operation 206 generates a tiered view of aggregated milestones from the table of milestones. In one implementation, the tiered management view includes: an aggregated order view with high level information of completed and pending orders; a milestone management view with individual tasks and owners of those tasks for an order; a global view of functional groups and their performance; and an order drilldown view with more granular detail about various tasks for an order. The tiered management view provides visibility and transparency of the orders and associated tasks and a single cohesive place to view one or more orders from start to finish.

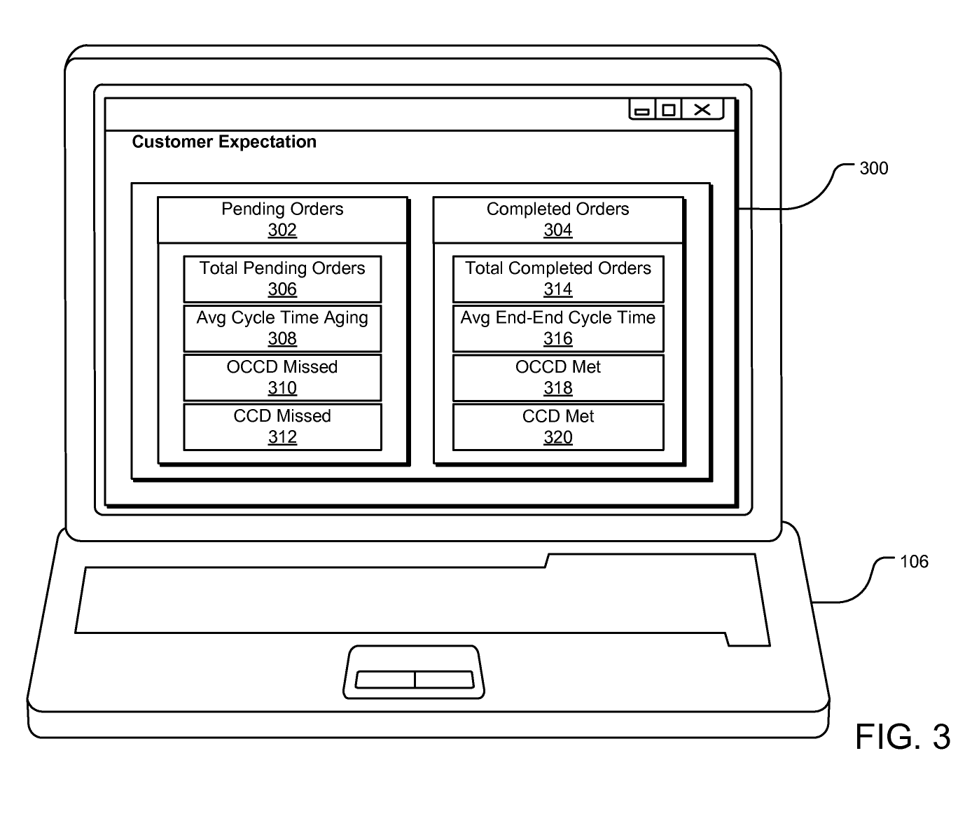

FIGS. 3-7 show example user interfaces generated by the quality milestone manager 102 and displayed with the user device 106 through which access to and interactions with order, task, milestone, and other analytic data are provided. FIGS. 3-7 reference VPN orders. It will be appreciated by those skilled in the art that such depictions are exemplary only and not intended to be limiting.

In one implementation, a user, such as a sales representative, a sales engineer, a CCM, sales delivery personnel, internal or external auditors, directors, or other interested parties accesses the quality milestone manager 102 via a link in an email or other notification or alert. In another implementation, the user accesses the quality milestone manager 102 directly by logging into an account with a browser window displayed with the user device 106.

FIG. 3 shows an example customer expectation user interface 300 displaying a pending orders view 302 and a completed orders view 304. The customer expectation user interface 300 provides a high level understanding and quick reference of completed versus pending orders.

In one implementation, the pending orders view 302 may be used to set customer expectations. The pending orders view 302 may include information regarding all the pending VPN orders. For example, the pending orders view 302 may include a total pending install orders 306, an average cycle time aging 308 (e.g., in days), a percentage missed of order customer completion dates 310, and a percentage missed of customer completion dates 312. The order customer completion date 310 is the predicted date of installation of the VPN, as estimated at the time of order. The customer completion date 312 is a predicted date for installation of the VPN, as estimated later in the process when more information about the design of the ordered VPN is available. The average cycle time aging 308 is the amount of time between the order customer completion date and the actual installation date of the VPN.

In one implementation, the completed orders view 304 provides metrics on completed orders and may provide an overall customer view for delivered orders during a time period. For example, the completed orders view 304 may include a total completed orders 314 over a timeframe, an average end to end cycle time 316 (e.g., in days), a percentage met of order customer completion dates 318, and a percentage met of customer completion dates 320. The average end to end cycle time 316 is the amount of time between order and installation of the VPN.

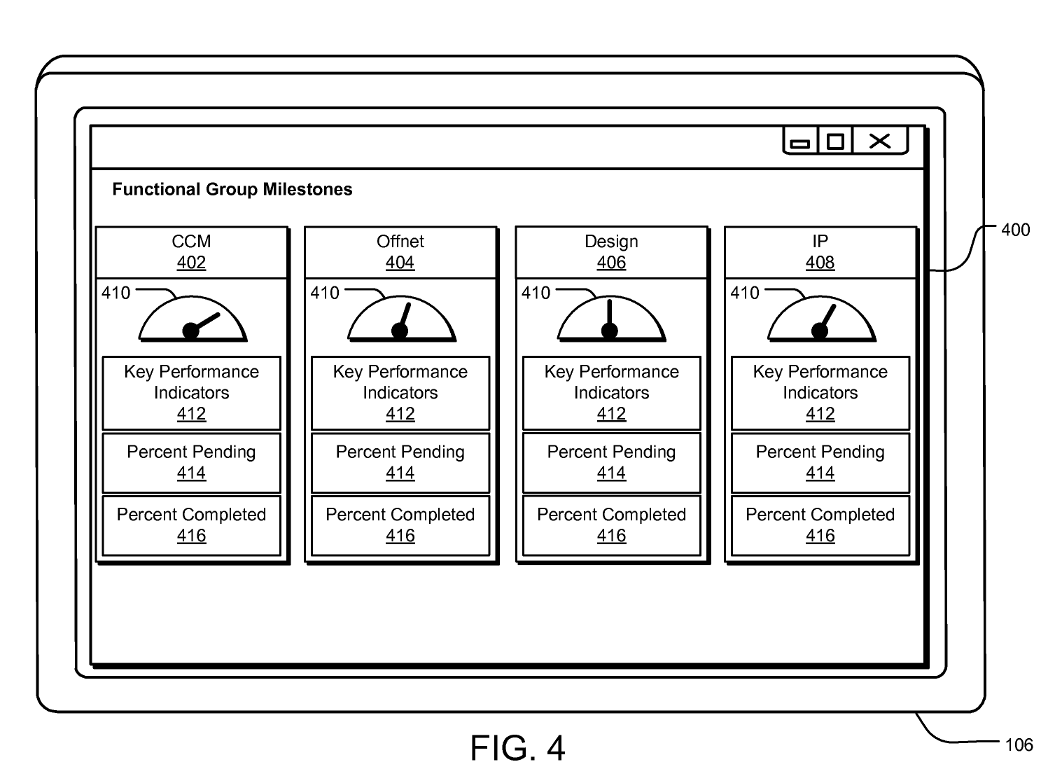

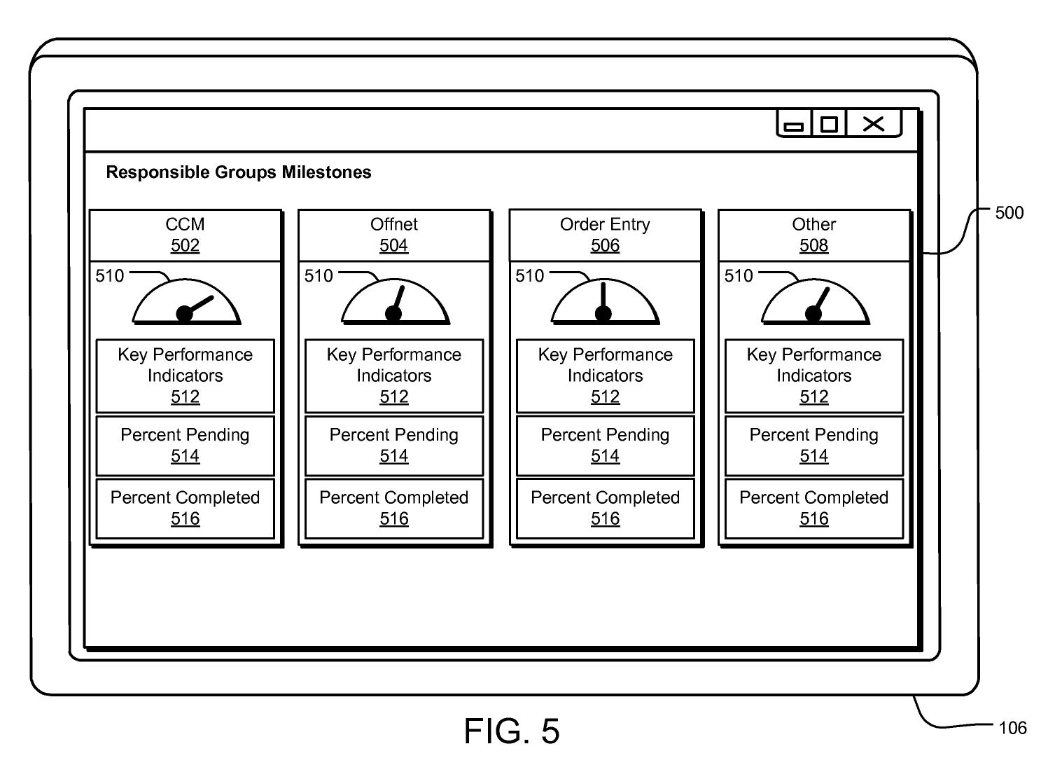

FIGS. 4-5 display example function group user interfaces 400 and 500 with key performance indicators. Each task for an order is assigned to a functional group. The function group user interface 400 shows milestones for pending orders by functional group, which may be used to understand which groups are delaying orders and an aging of tasks assigned to each of the functional groups.

In one implementation, the function group user interface 400 includes key performance indicators 412 for a CCM group 402, an offnet group 404, a design group 406, and an IP group 408. The key performance indicators 412 for the functional groups include, without limitation, a number of pending orders, an average task aging (e.g., in days), an average task SLA (e.g., in days), a number of completed orders, an average task time (e.g., in days), and an average task SLA (e.g., in days).

The functional group user interface 400 may also provide a quick reference of a percentage of pending tasks 414 and a percentage of completed tasks 416 for each of the functional groups. In one implementation, the function group user interface 400 includes a visual representation 410 of the performance of each of the functional groups. For example, the visual representation 410 may indicate a whether the functional group has more pending or completed tasks using color indicators. If a group is colored with green, the functional group has a higher percentage of completed tasks than pending tasks, and if a group is colored with red, the functional group has a higher percentage of pending tasks than completed tasks. Other visual cues may be displayed with the visual representation 410. For example, as shown in FIG. 4, the visual representation 410 may include a visual measuring gauge indicating a percentage of total orders completed.

The function group user interface 500 shows milestones for pending orders by responsible organization, which may be used to understand which responsible parties are delaying orders and which tasks assigned to each of the responsible parties are aging.

In one implementation, the function group user interface 500 includes key performance indicators 512 for a CCM group 502, an offnet group 504, an order entry group 506, and other groups 508 (e.g., a TDE group). The key performance indicators 512 for the responsible groups include, without limitation, a number of pending orders, an average task aging (e.g., in days), a number of completed orders, and an average task time (e.g., in days).

The functional group user interface 500 may also provide a quick reference of a percentage of pending tasks 514 and a percentage of completed tasks 516 for each of the functional groups. In one implementation, the function group user interface 500 includes a visual representation 510 of the performance of each of the functional groups. For example, the visual representation 510 may indicate a whether the functional group has more pending or completed tasks using color indicators. If a group is colored with green, the functional group has a higher percentage of completed tasks than pending tasks, and if a group is colored with red, the functional group has a higher percentage of pending tasks than completed tasks. Other visual cues may be displayed with the visual representation 510. For example, as shown in FIG. 5, the visual representation 510 may include a visual measuring gauge indicating a percentage of total orders completed.

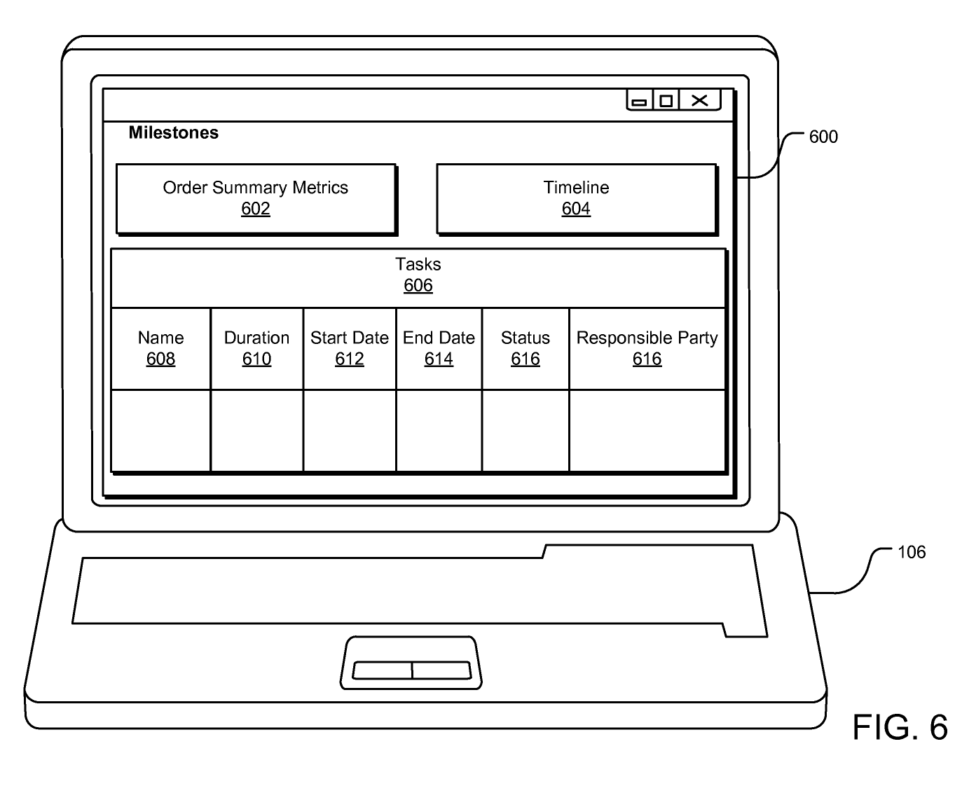

FIG. 6 displays an example milestone view 600 with tasks for an order and parties responsible for the tasks. In one implementation, the milestone view 600 includes a timeline 604 of milestones at the task level and shows tasks 606 that are initiated by the quality milestone manager 102, as well as predicted future tasks for the order assuming a normal path. The milestone view 600 may be used to estimate task completion time and where delays are originating. Based on the information in the milestone view 600, a party responsible for an aging task may be contacted to remedy the issues causing the delay to meet customer completion dates, provide more accurate estimations for the customer, and increase customer satisfaction with regular updates.

In one implementation, the milestone view 600 includes summary metrics 602 for the order, including, without limitation, an order number, a number of days until the customer completion date, an order customer sign date, a customer sign date, a customer accept date, a signed acknowledgment received date, an order customer completion date, a customer completion date, and an estimated number of days until completion.

The milestone view 600 further includes a table of information corresponding to all the tasks 606, including, without limitation, a task name 608, a duration period 610, a start date 612, an end date 614, a status 616, and a responsible party 616. In one implementation, the status 616 of each task is also shown in the timeline 604 with a color reflecting whether the status is completed, pending, or predictive or unassigned. The timeline 604 may be used to predict future tasks and estimate a time until installation.

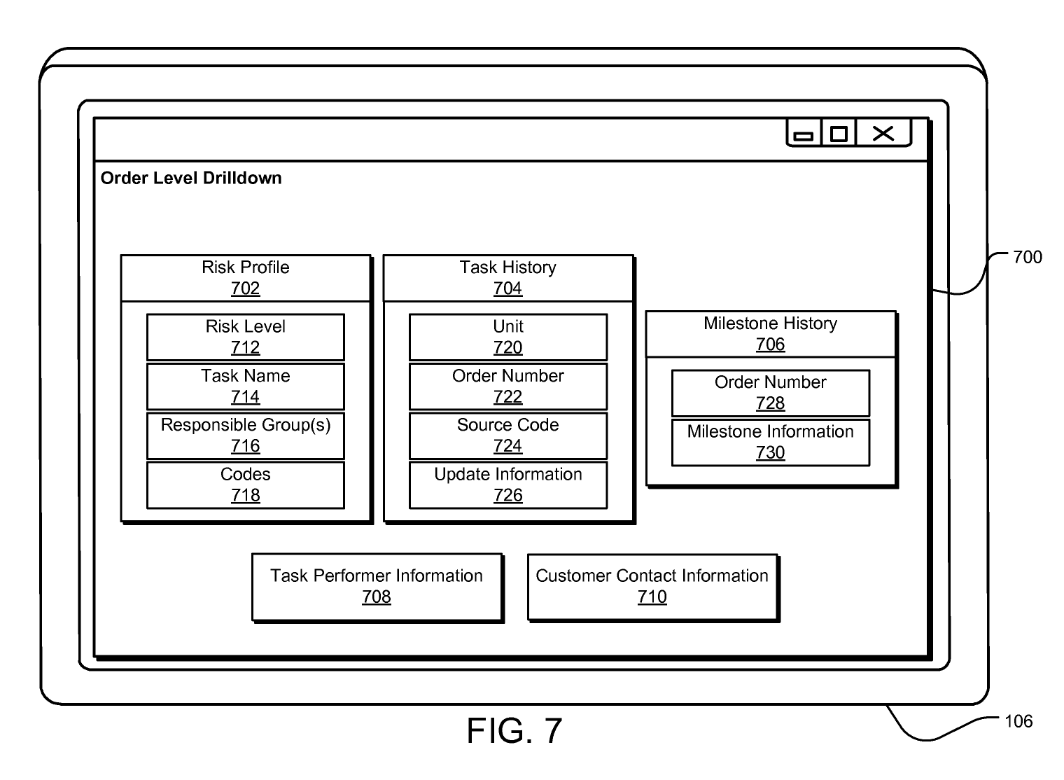

FIG. 7 shows an example order level drill down view 700 of an order and associated tasks. In one implementation, the order level drill down view 700 includes a risk profile 702, task history 704, milestone history 706, task performer information 708, and customer contact information 710.

The risk profile 702 includes a risk level 712, providing information on whether a task is at risk for missing a deadline. For example, the risk level 712 may utilize color coding to provide a quick visual reference of high risk tasks and other statuses of tasks. In one implementation, the risk profile 702 further details a task name 714, responsible group(s) 716 for the task (e.g., an offnet responsible organization, an onnet responsible organization, etc.), and task codes 718. In one implementation, the risk profile 702 shows the latest codes 718 for the order and opens the task history 704 upon selection of a link. The task history 704 provides more information about a task shown in the risk profile 702. For example, the task history 704 may include a service order unit 720, a service order number 722, data source code 724, and update information 726 for the task. The update information 726 may include, for example, a username of the last user to update the task, a timestamp for the update, a value, an identification, a start date, an end date, and a cycle time.

In one implementation, the milestone history 706 includes a service order number 728 and milestone information 730, which provides a timeline of milestones at the task level and shows tasks that are initiated by the quality milestone manager 102, as well as predicted future tasks for the order assuming a normal path. The milestones information 730 for each order includes a link which may be selected to view the order, tasks, or milestones.

In one implementation, the task performer information 708 lists the contact information for the various user assigned tasks for the order. The task performer information 708 may be used to trigger an automatic email or other notification to one or more task performers to take action against a pending task to reduce the cycle time, for example. In one implementation, the customer contact information 710 may be integrated with communication systems to enable a user, such as the CCM, to easily contact the customer regarding the order.

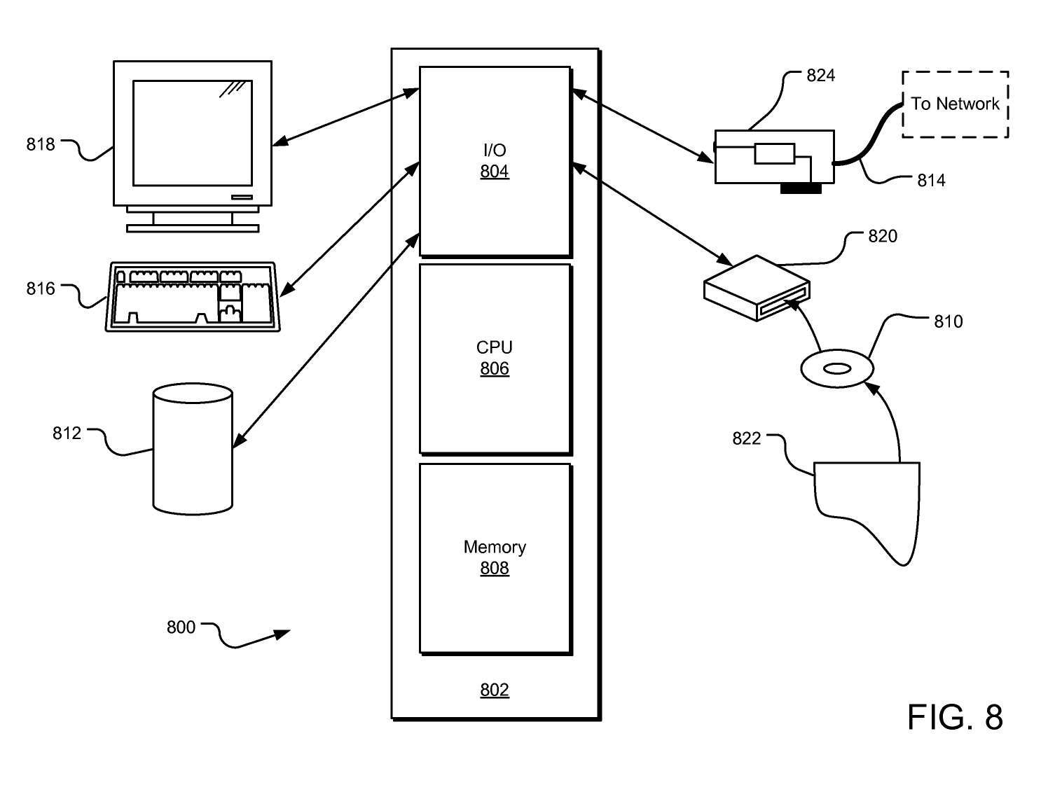

FIG. 8 is an example computing system 800 that may implement various systems and methods discussed herein. A general purpose computer system 800 is capable of executing a computer program product to execute a computer process. Data and program files may be input to the computer system 800, which reads the files and executes the programs therein. Some of the elements of a general purpose computer system 800 are shown in FIG. 8 wherein a processor 802 is shown having an input/output (I/O) section 804, a Central Processing Unit (CPU) 806, and a memory section 808. There may be one or more processors 802, such that the processor 802 of the computer system 800 comprises a single central-processing unit 806, or a plurality of processing units, commonly referred to as a parallel processing environment. The computer system 800 may be a conventional computer, a distributed computer, or any other type of computer, such as one or more external computers made available via a cloud computing architecture. The presently described technology is optionally implemented in software devices loaded in memory 808, stored on a configured DVD/CD-ROM 810 or storage unit 812, and/or communicated via a wired or wireless network link 814, thereby transforming the computer system 800 in FIG. 8 to a special purpose machine for implementing the described operations.

The I/O section 804 is connected to one or more user-interface devices (e.g., a keyboard 816 and a display unit 818), a disc storage unit 812, and a disc drive unit 820. Generally, the disc drive unit 820 is a DVD/CD-ROM drive unit capable of reading the DVD/CD-ROM medium 810, which typically contains programs and data 822. Computer program products containing mechanisms to effectuate the systems and methods in accordance with the presently described technology may reside in the memory section 804, on a disc storage unit 812, on the DVD/CD-ROM medium 810 of the computer system 800, or on external storage devices made available via a cloud computing architecture with such computer program products, including one or more database management products, web server products, application server products, and/or other additional software components. Alternatively, a disc drive unit 820 may be replaced or supplemented by a floppy drive unit, a tape drive unit, or other storage medium drive unit. The network adapter 824 is capable of connecting the computer system 800 to a network via the network link 814, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 800 is connected (by wired connection or wirelessly) to a local network through the network interface or adapter 824, which is one type of communications device. When used in a WAN-networking environment, the computer system 800 typically includes a modem, a network adapter, or any other type of communications device for establishing communications over the wide area network. In a networked environment, program modules depicted relative to the computer system 800 or portions thereof, may be stored in a remote memory storage device. It is appreciated that the network connections shown are examples of communications devices for and other means of establishing a communications link between the computers may be used.

In an example implementation, order and task data, milestone date, key performance indicators, the quality milestone manager 102, a plurality of internal and external databases (e.g., the database 116), source databases, and/or data cached on cloud servers are stored as the memory 808 or other storage systems, such as the disk storage unit 612 or the DVD/CD-ROM medium 810, and/or other external storage devices made available and accessible via a cloud computing architecture. Aggregated milestone generation and management software and other modules and services may be embodied by instructions stored on such storage systems and executed by the processor 802.

Some or all of the operations described herein may be performed by the processor 802. Further, local computing systems, remote data sources and/or services, and other associated logic represent firmware, hardware, and/or software configured to control operations of the order management system 100. Such services may be implemented using a general purpose computer and specialized software (such as a server executing service software), a special purpose computing system and specialized software (such as a mobile device or network appliance executing service software), or other computing configurations. In addition, one or more functionalities of the order management system 100 disclosed herein may be generated by the processor 802 and a user may interact with a Graphical User Interface (GUI) (e.g., the user interfaces 300-700) using one or more user-interface devices (e.g., the keyboard 816, the display unit 818, and the user devices 106) with some of the data in use directly coming from online sources and data stores. The system set forth in FIG. 8 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A method for quality milestone management comprising:
obtaining a plurality of orders using disparate quoting systems;
extracting milestone information corresponding to the plurality of orders using at least one processor, the milestone information including a plurality of tasks for each of the plurality of orders;
correlating the milestone information into a table of milestones for the plurality of orders using the at least one processor, the table of milestones identifying a start date, an end date, and a status for each of the plurality of tasks;
generating aggregated milestones from the table of milestones using the at least one processor, the aggregated milestones including aggregated orders and milestone management information, the aggregated orders detailing an amount of completed orders from the plurality of orders and an amount of pending orders from the plurality of orders, the milestone management information detailing the plurality of tasks for each of the orders; and
outputting the aggregated milestones in a tiered view for display on a user device.

2. The method of claim 1, wherein the milestone management information further details one or more responsible parties assigned to each of the plurality of tasks.

3. The method of claim 1, further comprising:
generating key performance indicators for one or more functional groups involved in a completion of the plurality of orders.

4. The method of claim 3, wherein the key performance indicators include at least one of: a number of pending orders, a number of completed orders, an average task aging, a number of completed orders, or an average task time.

5. The method of claim 1, wherein the aggregated milestones further include order drilldown information providing granular detail about one or more of the plurality of tasks.

6. The method of claim 1, wherein the milestone management information provides a timeline of milestones for the plurality of tasks.

7. The method of claim 6, wherein the timeline of milestones includes predicted future tasks.

8. The method of claim 1, wherein the milestone management information provides order summary metrics.

9. The method of claim 8, wherein the order summary metrics include at least one of: time until a customer completion date and an estimated time until completion.

10. The method of claim 1, further comprising:
generating analytics based on the aggregated milestones.

11. The method of claim 10, wherein the analytics include at least one of: one or more recurring order process issues, one or more accountable parties, one or more causes of recurring delays, one or more recurring defects, or a snapshot of order quality.

12. The method of claim 1, wherein the plurality of orders are for one or more telecommunication services.

13. The method of claim 12, wherein the one or more telecommunication services includes a Virtual Private Network.

14. One or more tangible non-transitory computer-readable storage media storing computer-executable instructions for performing a computer process on a computing system, the computer process comprising:
obtaining a plurality of orders using disparate quoting systems;
extracting milestone information corresponding to the plurality of orders using at least one processor, the milestone information including a plurality of tasks for each of the plurality of orders;
correlating the milestone information into a table of milestones for the plurality of orders using the at least one processor, the table of milestones identifying a start date, an end date, and a status for each of the plurality of tasks; and
generating aggregated milestones from the table of milestones using the at least one processor, the aggregated milestones including aggregated orders and milestone management information, the aggregated orders detailing an amount of completed orders from the plurality of orders and an amount of pending orders from the plurality of orders, the milestone management information detailing the plurality of tasks for each of the orders.

15. The one or more tangible non-transitory computer-readable storage media of claim 14, further comprising:
outputting the aggregated milestones in a tiered view for display on a user device.

16. The one or more tangible non-transitory computer-readable storage media of claim 14, further comprising:
generating key performance indicators for one or more functional groups involved in a completion of the plurality of orders.

17. A system for quality milestone management comprising:
a plurality of disparate quoting systems configured to generate a plurality of orders from order attributes; and
a quality milestone manager in communication with the plurality of disparate quoting systems, the quality milestone manager executable by a processor and configured to generate aggregated milestones from a table of milestones correlated from milestone information including a plurality of tasks for each of the plurality of orders, the aggregated milestones including an aggregated orders and milestone management information.

18. The system of claim 17, wherein the table of milestones identifying a start date, an end date, and a status for each of the plurality of tasks.

19. The system of claim 17, wherein the aggregated orders detailing an amount of completed orders from the plurality of orders and an amount of pending orders from the plurality of orders and the milestone management information detailing the plurality of tasks for each of the orders.

20. The system of claim 17, further comprising:
one or more user devices in communication with the quality milestone manager and configured to receive and display the aggregated milestones in a tiered view.
